(19) United States
(12) Patent Application Publication
(10) Pub. No.: US 2024/0355257 A1
(43) Pub. Date: Oct. 24, 2024

(54) DISPLAY DEVICE AND OPERATING METHOD THEREOF

(71) Applicant: LG ELECTRONICS INC., Seoul (KR)

(72) Inventors: Jung Wook LEE, Seoul (KR); Jong Ho PARK, Seoul (KR)

(73) Assignee: LG ELECTRONICS INC., Seoul (KR)

(21) Appl. No.: 18/639,680

(22) Filed: Apr. 18, 2024

(30) Foreign Application Priority Data
Apr. 19, 2023 (KR) 10-2023-0051535
Jul. 31, 2023 (KR) 10-2023-0100099

(51) Int. Cl. G09G 3/20; G09G 3/34; G09G 3/36

(52) U.S. Cl. CPC G09G 3/2007; G09G 3/3406; G09G 3/36; G09G 2320/066; G09G 2330/021; G09G 2360/144

(57) ABSTRACT

A display device according to an embodiment of the present disclosure may comprise: a display panel; a backlight unit configured to output a light to the display panel; and a control unit configured to: decrease a light output intensity of the backlight unit according to a remaining amount of the battery if the display device is supplied with power from a battery, adjust a gain of a dynamic tone mapping curve and a gain of a dynamic contrast curve for an input image signal according to a decrease of the light output intensity, and output an output image signal generated according to the adjustment of each gain to the display panel.

### CROSS-REFERENCE TO RELATED APPLICATIONS

Pursuant to 35 U.S.C. § 119 (a), this application claims the benefit of earlier filing date and right of priority to Korean Patent Application Nos. 10-2023-0051535, filed on Apr. 19, 2023 and 10-2023-0100099, filed on Jul. 31, 2023, the contents of which are all hereby incorporated by reference herein in their entirety.

### TECHNICAL FIELD

The present disclosure relates to a display device and an operating method thereof.

### BACKGROUND ART

A liquid crystal display of an active matrix driving method displays a moving picture using a thin film transistor (hereinafter referred to as “TFT”) as a switching element.

Liquid crystal display device can be miniaturized compared to Cathode Ray Tube (CRT), so it is applied to display device such as portable information device, office device, and computer, as well as television, rapidly replacing cathode ray tube.

A transmissive liquid crystal display, which occupies most of the liquid crystal display, displays an image by modulating light incident from a backlight unit by controlling an electric field applied to a liquid crystal layer.

In the case of a display device equipped with a battery, if an image is reproduced through the display device using a battery, light output intensity of a backlight unit may be reduced to prevent waste of power consumption.

If the light output intensity of the backlight unit is reduced, the image becomes dark, which may interfere with the user's viewing of the image.

In addition, even in a bright outdoor environment, a decrease in the light output intensity of the backlight unit causes a decrease in visual brightness, resulting in a darkening of the image.

### DISCLOSURE

### Technical Problem

An object of the present disclosure is to prevent an image from becoming dark due to a decrease in light output intensity of a backlight unit through compensation of an image signal if a display device is supplied with power through a battery.

An object of the present disclosure is to compensate for an image signal according to measured illuminance if a display device is supplied with power through a battery.

### Technical Solution

A display device according to an embodiment of the present disclosure may comprise: a display panel; a backlight unit configured to output a light to the display panel; and a control unit configured to: decrease a light output intensity of the backlight unit according to a remaining amount of the battery if the display device is supplied with power from a battery, adjust a gain of a dynamic tone mapping curve and a gain of a dynamic contrast curve for an input image signal according to a decrease of the light output intensity, and output an output image signal generated according to the adjustment of each gain to the display panel.

A method of operating a display device according to an embodiment of the present disclosure may comprise: decreasing a light output intensity of the backlight unit according to a remaining amount of the battery if the display device is supplied with power from a battery, adjusting a gain of a dynamic tone mapping curve and a gain of a dynamic contrast curve for an input image signal according to a decrease of the light output intensity, and outputting an output image signal generated according to the adjustment of each gain to the display panel.

### Advantageous Effects

According to the present disclosure, even if the light output intensity of the backlight unit is reduced, the screen may be prevented from becoming dark through compensation of the image signal. Accordingly, the user's viewing experience may be improved.

According to the present disclosure, if viewing a video in a bright environment outdoor, a image signal is processed to allow a brighter screen to be viewed, so that the user's video viewing experience can be improved.

### DESCRIPTION OF DRAWINGS

FIG. 1 is a diagram illustrating a display device according to an embodiment of the present disclosure.

FIG. 2 is a block diagram illustrating the configuration of the display device of FIG. 1.

FIG. 3 is an example of an internal block diagram of the control unit of FIG. 2.

FIG. 4 is an internal block diagram of a power supply unit and a display module of FIG. 2.

FIG. 5 is an internal block diagram of the power supply unit and display of FIG. 2.

FIG. 6 is an exemplary view showing the arrangement of a liquid crystal display panel and light sources in case of an edge type backlight unit.

FIG. 7 is an exemplary view showing the arrangement of a liquid crystal display panel and light sources in the case of a direct type backlight unit.

FIG. 8 is a diagram explaining a method of operating a display device according to an embodiment of the present disclosure.

FIG. 9 is a graph illustrating a relationship between light output intensity of a backlight unit and a remaining amount of a battery according to an embodiment of the present disclosure.

FIG. 10 is a diagram for explaining a DTM curve in which gain is adjusted according to an embodiment of the present disclosure.

FIG. 11 is a diagram for explaining a DC curve of which gain is adjusted according to an embodiment of the present disclosure.

FIG. 12 is a diagram for illustrating an example of adjusting a gain of a DTM curve and a gain of a DC curve if power is supplied to a display device through a battery and the illuminance measured by an illuminance sensor is equal to or greater than a certain illuminance according to an embodiment of the present disclosure.

FIG. 13 is a diagram for explaining a method of determining whether the embodiment of the present disclosure described in FIG. 8 is applied.

### BEST MODE

Hereinafter, the present specification will be described in more detail with reference to the drawings.

The suffixes “module” and “unit” for the component used in the following description are simply given in consideration of ease of writing this specification, and do not themselves give a particularly important meaning or role. Accordingly, the “module” and “unit” may be used interchangeably.

Terms including ordinal number, such as first and second, may be used to describe various components, but the components are not limited by the terms. These terms are only used for the purpose of distinguishing one component from another.

Singular expression includes plural expressions unless the context clearly dictates otherwise.

In this application, terms such as “comprise” or “have” are intended to designate that there is a feature, number, step, operation, component, part, or combination thereof described in the specification, but it should be understood that one or more other features, the presence or addition of number, step, operation, component, part, or combination are not precluded.

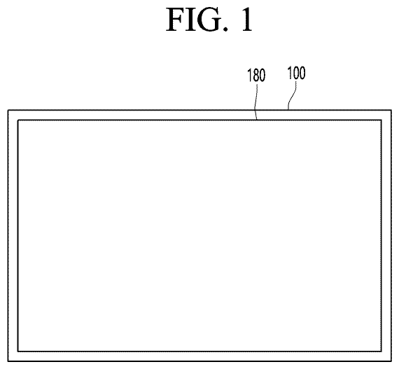

FIG. 1 is a diagram illustrating a display device according to an embodiment of the present disclosure.

Referring to the drawing, the display device 100 may include a display unit 180.

Meanwhile, the display unit 180 may be implemented with any one of various panels.

In the present disclosure, it is assumed that the display unit 180 includes a liquid crystal display panel (LCD panel). Hereinafter, the display device 100 may be a liquid crystal display device.

Meanwhile, the display device 100 of FIG. 1 may be a monitor, a TV, a tablet PC, or a mobile terminal.

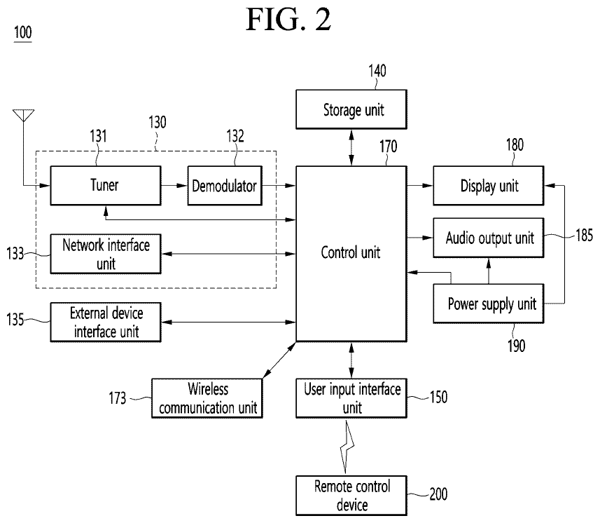

FIG. 2 is a block diagram illustrating the configuration of the display device of FIG. 1.

Referring to FIG. 2, the display device 100 includes a broadcast reception unit 130, an external device interface unit 135, a storage unit 140, a user input interface unit 150, a control unit 170, and a wireless communication unit 173, a display unit 180, an audio output unit 185, and a power supply unit 190.

The broadcast receiving unit 130 may include a tuner 131, a demodulation unit 132 and a network interface unit 133.

The tuner 131 may select a specific broadcasting channel according to a channel selection command. The tuner 131 may receive a broadcast signal for a selected specific broadcast channel.

The demodulator 132 may separate the received broadcast signal into a image signal, an audio signal, and a data signal related to the broadcast program, and restore the separated image signal, audio signal, and data signal into a form capable of being output.

The network interface unit 133 may provide an interface for connecting the display device 100 to a wired/wireless network including the Internet network.

The external device interface unit 135 may receive an application or an application list in an adjacent external device and transfer the received application to the control unit 170 or the storage unit 140.

The external device interface unit 135 may provide a connection path between the display device 100 and an external device. The external device interface unit 135 may receive at least one of video and audio output from an external device connected to the display device 100 by wire or wirelessly, and transmit the received image to the control unit 170.

The external device interface unit 135 may include a plurality of external input terminals. The plurality of external input terminals may include an RGB terminal, one or more High Definition Multimedia Interface (HDMI) terminals, and component terminals.

An image signal of an external device input through the external device interface unit 135 may be output through the display unit 180. The audio signal of the external device input through the external device interface unit 135 may be output through the audio output unit 185.

An external device connectable to the external device interface unit 135 may be any one of a set-top box, a Blu-ray player, a DVD player, a game machine, a sound bar, a smartphone, a PC, a USB memory, and a home theater, but this is only an example.

The storage unit 140 may store program for processing and controlling each signal in the control unit 170 and may store signal-processed video, audio, or data signal.

In addition, the storage unit 140 may perform a function for temporarily storing video, audio, or data signal input from the external device interface unit 135 or the network interface unit 133, and store information about the image through a channel storage function.

The user input interface unit 150 may transmit a signal input by the user to the control unit 170 or may transmit a signal from the control unit 170 to the user. For example, the user input interface unit 150 may receive and process control signals such as power on/off, channel selection, and screen setting from the remote control device 200, or process a control signal from the control unit 170 is transmitted to the remote control device 200 according to various communication methods such as Bluetooth, Ultra Wideband (WB), ZigBee, Radio Frequency (RF) communication, or IR (Infrared) communication.

In addition, the user input interface unit 150 may transmit a control signal input from a local key (not shown) such as a power key, a channel key, a volume key, and a set value to the control unit 170.

The image signal processed by the control unit 170 may be input to the display unit 180 and displayed as an image corresponding to the corresponding image signal. In addition, the image signal processed by the control unit 170 may be input to an external output device through the external device interface unit 135.

The audio signal processed by the control unit 170 may be output as audio to the audio output unit 185. Also, the voice signal processed by the control unit 170 may be input to an external output device through the external device interface unit 135.

In addition, the control unit 170 may control overall operations within the display device 100.

The control unit 170, according to an external device video playback command received through the user input interface unit 150, may output the image signal or the audio signal through the display unit 180 or the audio output unit 185 from an external device (for example, a camera or camcorder) input through the external device interface unit 135.

Meanwhile, the control unit 170 may control the display unit 180 to display an image, for example, a broadcast image input through the tuner 131 or an external input image through the external device interface unit 135, an image input through the network interface unit, or an image stored in the storage unit 140 may be controlled to be displayed on the display unit 180. In this case, the image displayed on the display unit 180 may be a still image or a moving image, and may be a 2D image or a 3D image.

In addition, the control unit 170 may control content stored in the display device 100, received broadcast content, or external input content input from the outside to be reproduced, and the content include various forms, such as a broadcast image, an external input image, an audio file, as still image, connected web screen, and document file.

The wireless communication unit 173 may communicate with an external device through wired or wireless communication. The wireless communication unit 173 may perform short range communication with an external device.

To this end, the wireless communication unit 173 may support using at least one of Bluetooth™, Bluetooth Low Energy (BLE), Radio Frequency Identification (RFID), Infrared Data Association (IrDA), Ultra Wideband (UWB), ZigBee, Near Field Communication (NFC), Wireless-Fidelity (Wi-Fi), Short-distance communication Wi-Fi Direct and Wireless Universal Serial Bus (Wireless Universal Serial Bus) technology.

The display unit 180 may convert the image signal, data signal, OSD signal processed by the control unit 170 or the image signal or data signal received from the external device interface unit 135 into R, G, and B signals, respectively, and generate a driving signal.

On the other hand, since the display device 100 shown in FIG. 1 is only one embodiment of the present disclosure. Some of the illustrated components may be integrated, added, or omitted according to specifications of the display device 100 that is actually implemented.

That is, if necessary, two or more components may be combined into one component, or one component may be subdivided into two or more components.

In addition, function performed in each block is for explaining an embodiment of the present disclosure, and the specific operation or device does not limit the scope of the present disclosure.

The audio output unit 185 receives the audio-processed signal from the control unit 170 and outputs it as audio.

The power supply 190 supplies corresponding power throughout the display device 100. In particular, the power supply 190 may supply a power to the control unit 170, which can be implemented in the form of a system on chip (SOC), the display unit 180 for displaying image, and the audio output unit 185 for outputting audio.

Specifically, the power supply unit 190 may include a converter that converts AC power to DC power and a dc/dc converter that converts the level of the DC power.

The remote control device 200 transmits user input to the user input interface unit 150.

To this end, the remote control device 200 may use Bluetooth, radio frequency (RF) communication, infrared (IR) communication, ultra wideband (UWB), ZigBee, or the like. In addition, the remote control device 200 may receive a video, audio, or data signal output from the user input interface unit 150 and display or output it as an audio on the remote control device 200.

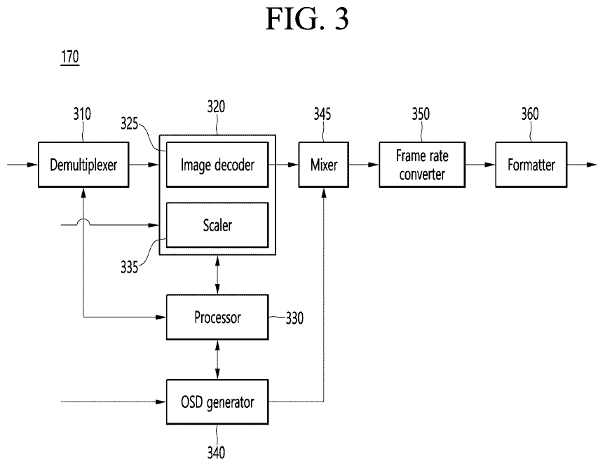

FIG. 3 is an example of an internal block diagram of the control unit of FIG. 2.

Referring to the drawings, the control unit 170 according to an embodiment of the present disclosure includes a demultiplexer 310, an image processor 320, a processor 330, an OSD generator 340, a mixer 345, a frame rate converter 350, and a formatter 360. In addition, an audio processing unit (not shown) and a data processing unit (not shown) may be further included.

The demultiplexer 310 demultiplexes the input stream. For example, if MPEG-2 TS is input, it can be demultiplexed and separated into video, audio, and data signals. Here, the stream signal input to the demultiplexer 310 may be a stream signal output from the tuner unit 110 or the demodulator 120 or the external device interface unit 130.

The image processing unit 320 may perform image processing of the demultiplexed image signal. To this end, the image processing unit 320 may include an image decoder 325 and a scaler 335.

The image decoder 325 decodes the demultiplexed image signal, and the scaler 335 performs scaling so that the resolution of the decoded image signal can be output on the display unit 180.

The image decoder 325 may include decoders of various standards. For example, an MPEG-2, H.264 decoder, a 3D image decoder for a color image and a depth image, a decoder for a multi-view image, and the like may be provided.

The processor 330 may control overall operations within the display device 100 or the control unit 170. For example, the processor 330 may control the tuner 110 to select (tuning) an RF broadcast corresponding to a channel selected by a user or a pre-stored channel.

Also, the processor 330 may control the display device 100 according to a user command input through the user input interface unit 150 or an internal program.

Also, the processor 330 may perform data transmission control with the network interface unit 135 or the external device interface unit 130.

In addition, the processor 330 may control operation of the demultiplexer 310, the image processor 320, the OSD generator 340, and the like within the control unit 170.

The OSD generating unit 340 generates an OSD signal according to a user input or by itself. For example, based on a user input signal, a signal for displaying various types of information in graphics or text on the screen of the display unit 180 may be generated. The generated OSD signal may include various data such as a user interface screen of the display device 100, various menu screens, widgets, and icons. Also, the generated OSD signal may include a 2D object or a 3D object.

Also, the OSD generator 340 may generate a pointer that can be displayed on the display unit 180 based on the pointing signal input from the remote control device 200. In particular, such a pointer may be generated by a pointing signal processing unit, and the OSD generation unit 340 may include such a pointing signal processing unit (not shown). Of course, it is also possible that the pointing signal processor (not shown) is not provided in the OSD generator 340 but is provided separately.

The mixer 345 may mix the OSD signal generated by the OSD generator 340 and the decoded image signal image-processed by the image processor 320. The mixed image signal is provided to the frame rate converter 350.

The frame rate converter (FRC) 350 may convert the frame rate of an input image. Meanwhile, the frame rate conversion unit 350 may output as it is without separate frame rate conversion.

Meanwhile, the formatter 360 may change the format of an input image signal into a image signal for display on a display and output the converted image signal.

The formatter 360 may change the format of the image signal. For example, the format of a 3D image signal, Side by Side format, Top/Down format, Frame Sequential format, Interlaced format, Checker Box may be changed to any one of various 3D formats such as format.

Meanwhile, an audio processing unit (not shown) in the control unit 170 may perform audio processing of the demultiplexed audio signal. To this end, the audio processing unit (not shown) may include various decoders.

Also, an audio processing unit (not shown) in the control unit 170 may process a base, treble, volume control, and the like.

A data processing unit (not shown) in the control unit 170 may perform data processing of the demultiplexed data signal. For example, if the demultiplexed data signal is an encoded data signal, it can be decoded. The encoded data signal may be electronic program guide information including broadcast information such as a start time and an end time of a broadcast program broadcast on each channel.

Meanwhile, the block diagram of the control unit 170 shown in FIG. 3 is a block diagram for an embodiment of the present disclosure. Each component of the block diagram may be integrated, added, or omitted according to specifications of the control unit 170 that is actually implemented.

In particular, the frame rate conversion unit 350 and the formatter 360 are not provided within the control unit 170, but may be separately provided or separately provided as one module.

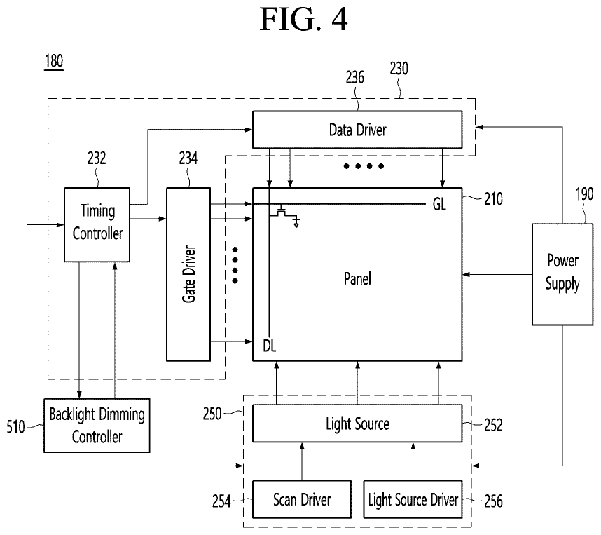

FIG. 4 is an internal block diagram of a power supply unit and a display module of FIG. 2.

Referring to the drawing, a display unit 180 based on a liquid crystal display panel (LCD panel) may include a liquid crystal display panel 210, a driving circuit unit 230, a backlight unit 250, and a backlight dimming control unit 510.

In the liquid crystal display panel 210, to display an image, a plurality of gate lines GL and data lines DL are disposed to cross each other in a matrix form, and may include a first substrate on which thin film transistor and pixel electrode connected to the thin film transistor are formed in the crossed region, a second substrate provided with a common electrode, and a liquid crystal layer formed between the first substrate and the second substrate.

The driving circuit unit 230 drives the liquid crystal display panel 210 through control signals and data signals supplied from the control unit 170 of FIG. 1. To this end, the driving circuit unit 230 includes a timing controller 232, a gate driver 234, and a data driver 236.

The timing controller 232 receives control signal, R, G, B data signal, and a vertical synchronization signal (Vsync) from the control unit 170, and controls the gate driver 234 and the data driver 236 in response to the control signal and rearranges the R, G, and B data signal and provides to the data driver 236.

According to the control of the gate driver 234, data driver 236, and timing controller 232, scan signal and image signal are supplied to the liquid crystal display panel 210 through the gate line GL and the data line DL.

The backlight unit 250 supplies light to the liquid crystal display panel 210. To this end, the backlight unit 250 may include a plurality of light sources 252 as light source, a scan driver 254 that controls scanning driving of the light sources 252, and a light source driving unit 256 for turning on/off the light sources 252.

With light transmittance of the liquid crystal layer adjusted by an electric field formed between the pixel electrode and the common electrode of the liquid crystal display panel 210, a predetermined image is displayed using light emitted from the backlight unit 250.

The power supply 190 may supply the common electrode voltage Vcom to the liquid crystal display panel 210 and supply the gamma voltage to the data driver 236. In addition, driving power for driving the light source 252 may be supplied to the backlight unit 250.

Meanwhile, the backlight unit 250 may be divided into a plurality of blocks and driven. The control unit 170 may control the display 180 to perform local dimming by setting dimming values of each of the plurality of blocks. Specifically, the timing controller 232 outputs the input image data RGB to the backlight dimming control unit 510, and the backlight dimming control unit 510 may calculate a dimming value of each of the plurality of blocks based on the input image data RGB received from the timing controller 232.

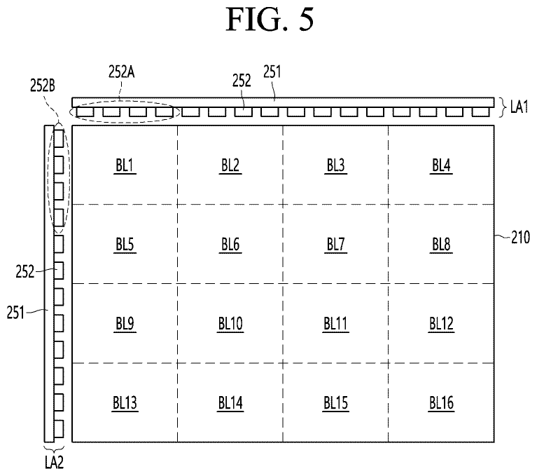

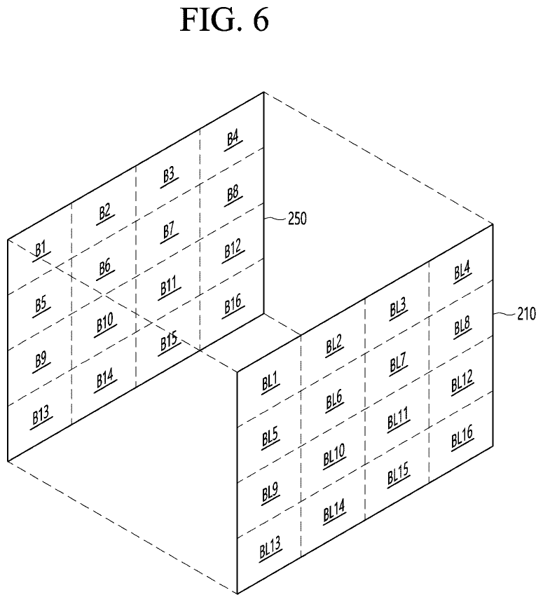

FIG. 5 is an exemplary view showing the arrangement of the liquid crystal display panel and light sources in case of an edge type backlight unit, and FIG. 6 is an example view showing the arrangement of the liquid crystal display panel and light sources in case of a direct type backlight unit.

The liquid crystal display panel 210 may be divided into a plurality of virtual blocks as shown in FIGS. 5 and 6. FIGS. 5 and 6 illustrate that the liquid crystal display panel 210 is equally divided into 16 blocks BL1 to BL16, but it should be noted that it is not limited thereto. Each of the plurality of blocks may include a plurality of pixels.

The backlight unit 250 may be implemented as either an edge type or a direct type.

The edge type backlight unit 250 has a structure in which a plurality of optical sheets and a light guide plate are stacked under the liquid crystal display panel 210, and a plurality of light sources are disposed on a side surface of the light guide plate.

If the backlight unit 250 is implemented as an edge-type backlight unit, light sources are disposed on at least one of upper and lower sides and at least one of left and right sides of the liquid crystal display panel 210. In FIG. 5, the first light source array LA1 is disposed on the upper side of the liquid crystal display panel 210 and the second light source array LA2 is disposed on the left side of the liquid crystal display panel 210 as an example. Each of the first and second light source arrays LA1 and LA2 includes a plurality of light sources 252 and a light source circuit board 251 on which the light sources 252 are mounted. In this case, the brightness of the light incident on the first block BL1 of the liquid crystal display panel 210 may be adjusted using the light sources 252A of the first light source array LA1 disposed at a position corresponding to the first block BL1 of the liquid crystal display panel 210 and the light sources 252B of the second light source array LA2.

The direct backlight unit 250 has a structure in which a plurality of optical sheets and a diffusion plate are stacked under the liquid crystal display panel 210 and a plurality of light sources are disposed under the diffusion plate.

If the backlight unit 250 is implemented as a direct type backlight unit, it is divided to correspond to the blocks BL1 to BL16 of the liquid crystal display panel 210 on a one-to-one basis, as shown in FIG. 6. In this case, the brightness of the light incident on the first block BL1 of the liquid crystal display panel 210 may be adjusted using the light sources 252 included in the first block BL1 of the backlight unit 250 disposed at a position corresponding to the first block BL1 of the liquid crystal display panel 210.

The light sources 252 may be implemented as point light sources such as light emitting diodes (LEDs). The light sources 252 are turned on and off by receiving the light source driving signals LDS from the light source driver 256. The light intensity of the light sources 252 may be adjusted according to the amplitude of the light source driving signals LDS, and the lighting period may be adjusted according to the pulse width. The brightness of light emitted from the light sources 252 may be adjusted according to the light source driving signal LDS.

The light source driving unit 256 may generate light source driving signals LDS based on a dimming value of each of the blocks input from the backlight dimming controller 510 and output the generated light source driving signals LDS to the light source 252. The dimming value of the blocks is a value for implementing local dimming and may be the brightness of light output from the light sources 252.

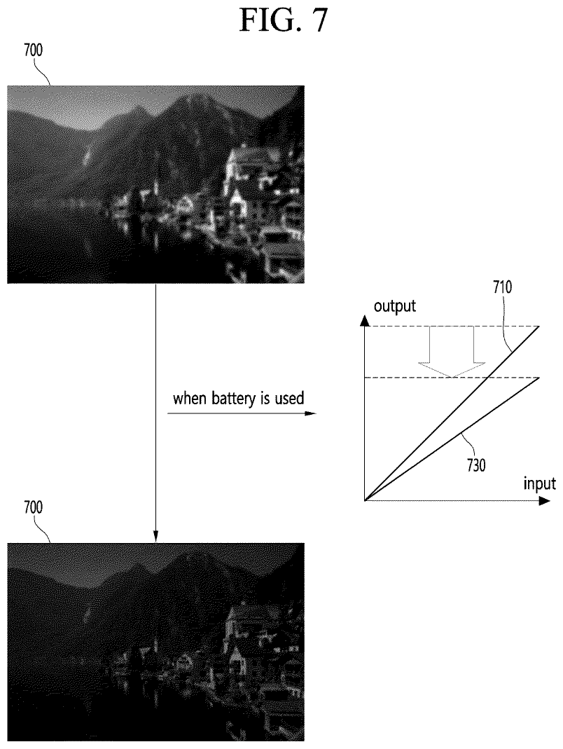

FIG. 7 is a diagram explaining a process of darkening an image if using a battery that provides power to a display device according to the prior art.

The battery of the display device 100 in FIG. 7 may be included in the power supply 190 of FIG. 2 or may be provided separately from the display device 100.

If the battery is provided separately from the display device 100, the battery may supply power to the display device 100 through the power supply unit 190 or the external device interface unit 135.

Referring to FIG. 7, the display device 100 is reproducing an image 700 before receiving power from a battery. In this case, the display device 100 may be supplied with AC power.

The display device 100 is disconnected from AC power and receives power from a battery. In this way, the display device 100 reduces the light output intensity of the backlight unit 250 to reduce power consumption if the battery is used.

That is, if the battery is used, the display device 100 reduces the light output intensity of the backlight unit 250 so that the first graph 710 representing the brightness of the output image signal versus the input image signal to be became the second graph 730.

The control unit 170 of the display device 100 transmits a dimming signal to decrease the light output intensity to the backlight dimming controller 510.

As the light output intensity of the backlight unit 250 decreases, the brightness of the image 700 becomes darker. Accordingly, since the user views a dark image, the user's viewing experience may be degraded.

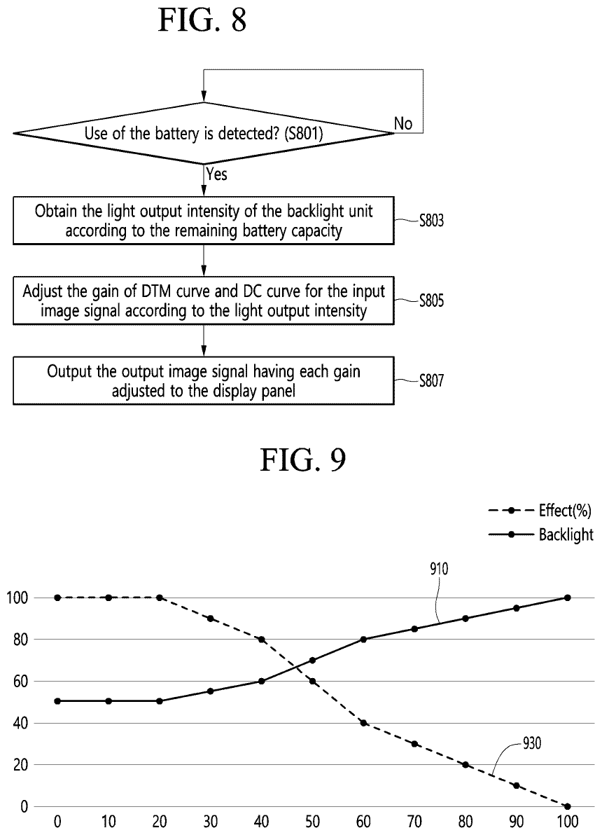

FIG. 8 is a flowchart illustrating a method of operating a display device according to an exemplary embodiment of the present disclosure.

Hereinafter, the battery may be included in the power supply 190 of the display device 100 or may be provided separately from the display device 100.

If the battery is provided separately from the display device 100, the battery may be connected to the external device interface unit 135 or the power supply unit 190 of the display device 100.

Referring to FIG. 8, the control unit 170 of the display device 100 may determine whether use of the battery is detected (S801).

In an embodiment, the control unit 170 may determine that use of the battery is detected if the display device 100 receives power from the battery.

In another embodiment, the control unit 170 may determine that the use of the battery has been detected if the display device 100 receives power from the battery instead of AC power.

The control unit 170 can identify power supplied from AC power and power supplied from a battery.

The control unit 170 may obtain the light output intensity of the backlight unit 250 according to the remaining battery capacity (S803).

If use of the battery is detected, the control unit 170 may obtain the remaining amount of the battery.

The control unit 170 may receive information about the remaining amount of the battery from the battery.

The control unit 170 may obtain the light output intensity of the backlight unit 250 corresponding to the obtained residual amount of the battery.

The storage unit 140 may store a lookup table indicating a correspondence between the remaining amount of the battery and the light output intensity of the backlight unit 250.

The control unit 170 may read the light output intensity of the backlight unit 250 matched to the remaining amount of battery by using a lookup table stored in the storage 140.

As the residual amount of the battery increases, the light output intensity of the backlight unit 250 may increase, and as the remaining amount of the battery decreases, the light output intensity of the backlight unit 250 may decrease.

FIG. 9 is a graph illustrating a relationship between light output intensity of a backlight unit and a remaining amount of a battery according to an embodiment of the present disclosure.

Referring to FIG. 9, a light output graph 910 may be a graph showing a relationship between the light output intensity of the backlight unit 250 according to the remaining battery level.

The light output graph 910 may have a tendency to indicate that the light output intensity of the backlight unit 250 increases as the remaining battery capacity increases.

The effect ratio graph 930 may be a graph indicating how greatly a change in light output intensity of the backlight unit 250 is applied according to the remaining battery power.

Again, FIG. 8 will be described.

The control unit 170 may adjust the gain of a dynamic tone mapping (DTM) curve and a dynamic contrast (DC) curve for the input image signal according to the obtained light output intensity (S805).

If the light output intensity of the backlight unit 250 decreases, the control unit 170 may sequentially adjust the gain of the DTM curve and the gain of the DC curve.

That is, if the light output intensity of the backlight unit 250 decreases, the control unit 170 may adjust the gain of the DC curve after adjusting the gain of the DTM curve.

The control unit 170 may receive an input image signal from any one of the broadcast receiver 130, the external device interface unit 135, and the wireless communication unit 173.

The dynamic tone mapping curve may be a curve representing a procedure of processing an output image signal with respect to an input image signal in an RGB domain.

The control unit 170 may increase the gain of the dynamic tone mapping curve according to the decrease of light output intensity of the backlight unit 250. To this end, the control unit 170 may process the input image signal so that the ratio of the value of the output image signal to the value of the input image signal exceeds 1 and has a value less than a preset value. The preset value may be a value set to prevent an excessively bright image from being output.

The control unit 170 may adjust the DTM curve to have a larger value than the straight line 1000 representing a 1:1 ratio, in which the ratio of the input value of the input image signal to the output value of the output image signal is 1.

The control unit 170 may adjust the gain of the DTM curve to increase the color depth of the input image signal. At the same time, the control unit 170 may smoothly adjust the DTM curve to make the slope of the curve of the portion corresponding to the high grayscale region, in order to minimize the degradation of the signal distinguishing power of the high grayscale region.

The control unit 170 may perform dynamic tone mapping on the input image signal through the DTM curve whose gain is adjusted, and then perform dynamic contrast mapping through the DC curve whose gain is adjusted.

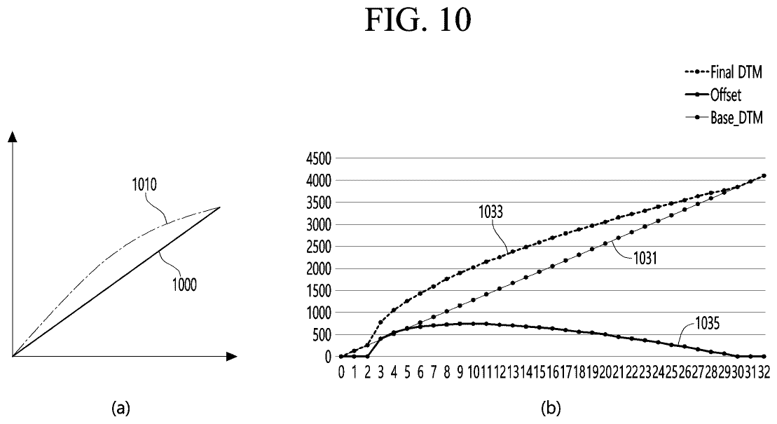

FIG. 10 is a diagram for explaining a DTM curve in which gain is adjusted according to an embodiment of the present disclosure.

Referring to FIG. 10(a), a straight line 1000 having a ratio of input value to output value of 1:1 is shown.

The control unit 170 may controls the DTM curve 1010 so that the APL (Average Picture Level) value of the point where the ratio of the input value of the input image signal and the output value of the output image signal is 1 has a greater value than the straight line 1000 representing the 1:1 ratio.

The control unit 170 may set an offset representing the degree of adjustment of the DTM curve according to the amount of change in light output intensity of the backlight unit 250.

The degree of adjustment of the DTM curve may be a value corresponding to the gain.

That is, the control unit 170 may change the first DTM curve 1031 to the second DTM curve 1033 based on the offset curve 1035 representing the offset, as shown in FIG. 10(b).

The offset curve 1033 may be a curve representing a difference between an output value of the first DTM curve 1031 and an output value of the second DTM curve 1033.

Again, FIG. 8 will be described.

After processing the input image signal through the DTM curve, the control unit 170 may compensate the processed image signal through the DC curve.

The DC curve may be a curve representing a procedure of processing an output image signal compared to an input image signal in the luminance (Y) domain.

The gain of the DC curve may be a parameter for adjusting the brightness of an image. As the gain of the DC curve increases, the contrast of a bright area may increase and the contrast of a dark area may decrease.

As the gain of the DC curve decreases, the contrast of a bright area may decrease and the contrast of a dark area may increase.

The gain of the DC curve can range between 0 and 1, but this is just an example.

The control unit 170 may correct the contrast of the image signal, which varies through the DTM curve, through the DC curve.

The control unit 170 may adjust the gain of the DC curve so that the ratio of the input value to the output value in the low grayscale region is less than 1 and the ratio of the input value to the output value in the high grayscale region is greater than 1.

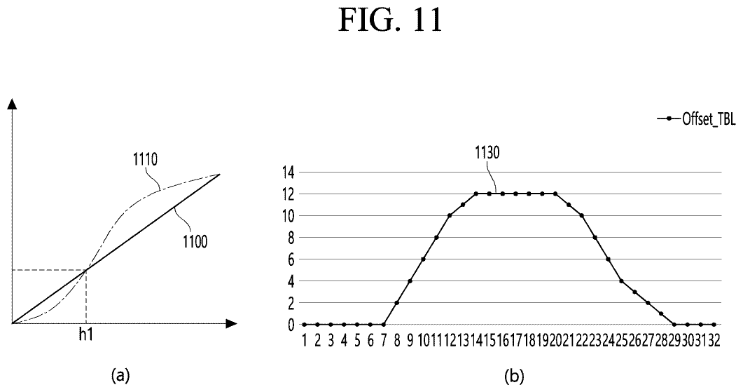

FIG. 11 is a diagram for explaining a DC curve of which gain is adjusted according to an embodiment of the present disclosure.

Referring to FIG. 11, the control unit 170 may change the DTM curve 1010 of FIG. 10(a) to the DC curve 1110 of FIG. 11 (a) to compensate for the image signal.

An input value smaller than h1 may correspond to a low grayscale region, and an input value greater than h1 may correspond to a high grayscale region.

The control unit 170 may generate the DC curve 1110 so that the ratio of the input value to the output value in the low grayscale region is less than 1 and the ratio of the input value to the output value in the high grayscale region is greater than 1.

Referring to FIG. 11(b), an offset curve 1130 showing the degree of adjustment of the DC curve 1110 according to the amount of change in light output intensity of the backlight unit 250 is shown.

The offset curve 1130 may be a curve representing a difference in output value between the base DC curve according to the adoption of the DTM curve 1010 and the DC curve 1110 to which the gain is adjusted.

Again, FIG. 8 will be described.

The control unit 170 may output the output image signal having each gain adjusted to the display panel 210 (S807).

According to an embodiment of the present disclosure, if a battery is used to supply power to the display device 100, as the light output intensity of the backlight unit 250 decreases, a darkened screen may be calibrated to a bright screen by using a DTM curve and a DC curve independent of power consumption.

Accordingly, the user's video viewing experience may be improved.

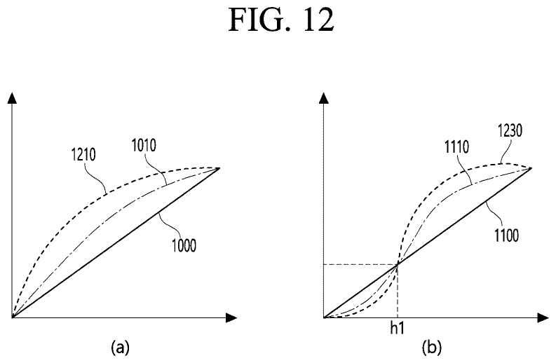

FIG. 12 illustrates an example of adjusting a gain of a DTM curve and a gain of a DC curve if power is supplied to a display device through a battery and the illuminance measured by an illuminance sensor is equal to or greater than a certain illuminance according to an embodiment of the present disclosure. it is a drawing

An illuminance sensor (not shown) may be provided in the display device 100 or may be provided separately from the display device 100.

If the illuminance sensor is provided separately from the display device 100, the control unit 170 of the display device 100 may receive the illuminance measured by the illuminance sensor from the illuminance sensor through the wireless communication unit 173.

FIG. 12(a) will be described.

The control unit 170 may change the existing DTM curve 1010 to a new DTM curve 1210 with an upwardly adjusted gain if the use of the battery is detected and the illuminance sensor measured by the illuminance sensor is higher than a certain level of illuminance.

The control unit 170 may generate a new DTM curve 1210 by increasing the gain of the DTM curve 1010 as battery use is detected and illumination increases.

The storage unit 140 may store a lookup table in which an illuminance value equal to or higher than a certain illuminance value and a gain value of the DTM curve are matched. The control unit 170 may obtain a gain of the DTM curve that matches the measured illuminance from the lookup table, and change the shape of the DTM curve according to the obtained gain.

Accordingly, even if the ambient illumination of the display device 100 increases, the brightness of the image signal is upwardly adjusted so that the user's image viewing experience can be improved.

Meanwhile, after generating the new DTM curve 1210, the control unit 170 may change the existing DC curve 1110 to a new DC curve 1230 with an increased gain to compensate for the image signal.

Accordingly, compared to the conventional DC curve 1110, the contrast of the low grayscale region may increase and the contrast of the dark region may decrease.

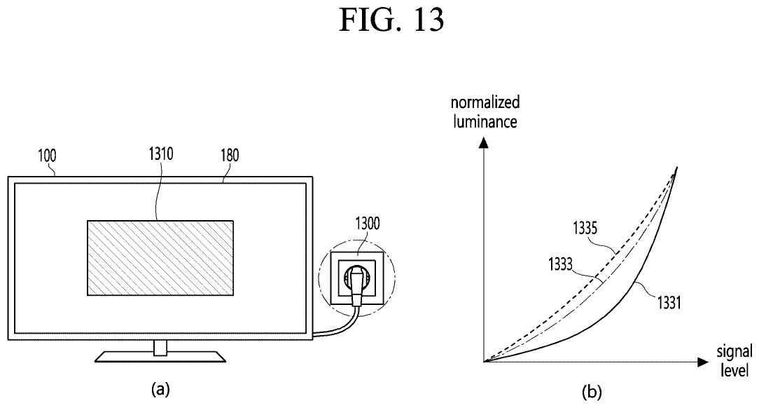

FIG. 13 is a diagram for explaining a method of determining whether the embodiment of the present disclosure described in FIG. 8 is applied.

Referring to FIG. 13(a), the display unit 180 of the display device 100 displays the internal pattern received from the pattern generator in the central area 1310. A fixed external pattern may be provided in areas other than the central area 1310.

The pattern generator may output the internal pattern on the central region 1310 of the display unit 180 while changing the signal level of the internal pattern from the black level to the white level.

Referring to of FIG. 13(b), if the display device 100 receives power from the AC power source 1300, a first curve 1331 showing a change in luminance according to a signal level and a power is supplied from a battery to the display device 100, a second curve 1333 showing a change in luminance according to a signal level are shown.

That is, if a higher luminance is measured for the same signal level in the central region 1310 if the battery is used, it can be confirmed that the gain of the DTM curve has been adjusted according to an embodiment of the present disclosure.

Also, referring to FIG. 13(b), if the display device 100 receives power from a battery and the illuminance measured by illuminance sensor is greater than a certain illuminance, a third curve 1335 showing a change in luminance according to a signal level is shown.

That is, if the use of the battery is detected, the illuminance measured by the illuminance sensor is above a certain level of illumination, and the same signal level versus luminance measured in the central region 1310 is higher than the case where only the use of the battery is detected, it may be confirmed that the gain of the DTM curve is adjusted according to the embodiment of the present disclosure.

The present disclosure described above can be implemented as computer readable codes in a medium on which a program is recorded. A computer-readable medium includes all types of recording devices in which data that can be read by a computer system is stored. Examples of computer-readable media include Hard Disk Drive (HDD), Solid State Disk (SSD), Silicon Disk Drive (SDD), ROM, RAM, CD-ROM, magnetic tape, floppy disk, optical data storage device, etc. Also, the computer may include the control unit 170 of the display device 100. Accordingly, the above detailed description should not be construed as limiting in all respects and should be considered as illustrative.

What is claimed is:

1. A display device, comprising:
a display panel;
a backlight unit configured to output a light to the display panel; and
a control unit configured to:
decrease a light output intensity of the backlight unit according to a remaining amount of a battery supplying power to the display device,
adjust a gain of a dynamic tone mapping curve and a gain of a dynamic contrast curve for an input image signal according to the decrease of the light output intensity, and
output, via the display panel, an output image signal generated according to the adjusted gains.

2. The display device of claim 1, wherein the gain of the dynamic tone mapping curve is adjusted after the gain of the dynamic contrast curve is adjusted.

3. The display device of claim 2, wherein the gain of the dynamic tone mapping curve is increased after the gain of the dynamic contrast curve is increased.

4. The display device of claim 2, wherein the gain of the dynamic tone mapping curve is adjusted so that a first ratio of a first input value to a second output value of the input image signal exceeds 1 and has a value less than a preset value.

5. The display device of claim 4, wherein the gain of the dynamic tone mapping curve is adjusted to smooth a slope of a curve of a portion corresponding to a high grayscale region.

6. The display device of claim 4, wherein the gain of the dynamic contrast curve is adjusted so that a second ratio of a second input value to a second output value in a low grayscale region is less than 1 and the second ratio of the second input value to the second output value in a high grayscale region is greater than 1.

7. The display device of claim 3, wherein the control unit is configured to:
further increase the gain of the dynamic tone mapping curve and thereafter further increase the gain of the dynamic contrast curve based on an illuminance measured by an illuminance sensor being greater than or equal to a certain illuminance threshold.

8. The display device of claim 1, wherein the battery is provided separately from the display device.

9. A method of operating a display device including a display panel and a backlight unit outputting light to the display panel, comprising:
decreasing a light output intensity of the backlight unit according to a remaining amount of a battery supplying power to the display device,
adjusting a gain of a dynamic tone mapping curve and a gain of a dynamic contrast curve for an input image signal according to the decrease of the light output intensity, and
outputting, via the display panel, an output image signal generated according to the adjusted gains.

10. The method of claim 9, wherein the gain of the dynamic tone mapping curve is adjusted after the gain of the dynamic contrast curve is adjusted.

11. The method of claim 10, wherein the gain of the dynamic tone mapping curve is increased after the gain of the dynamic contrast curve is increased.

12. The method of claim 10, wherein the gain of the dynamic tone mapping curve is adjusted so that a first ratio of a first input value to a second output value of the input image signal exceeds 1 and has a value less than a preset value.

13. The method of claim 12, wherein the gain of the dynamic tone mapping curve is adjusted to smooth a slope of a curve of a portion corresponding to a high grayscale region.

14. The method of claim 12, wherein the gain of the dynamic contrast curve is adjusted so that a second ratio of a second input value to a second output value in a low grayscale region is less than 1 and the second ratio of the second input value to the second output value in a high grayscale region is greater than 1.

15. The method of claim 11, further comprising:
further increasing the gain of the dynamic tone mapping curve and thereafter further increasing the gain of the dynamic contrast curve based on an illuminance measured by an illuminance sensor being greater than or equal to a certain illuminance threshold.
